(19) United States
(12) Patent Application Publication
(10) Pub. No.: US 2012/0017883 A1
(43) Pub. Date: Jan. 26, 2012

(54) APPARATUS AND METHOD FOR INSULATING AN APPLIANCE

(75) Inventors: Scott A. Campen, Knoxville, TN (US); William A. Kunkler, Heath, OH (US); Jason M. Seward, Nashport, OH (US)

(73) Assignee: OWENS CORNING INTELLECTUAL CAPITAL, LLC, Toledo, OH (US)

(21) Appl. No.: 13/187,036

(22) Filed: Jul. 20, 2011

Related U.S. Application Data
(60) Provisional application No. 61/365,815, filed on Jul. 20, 2010.

(51) Int. Cl. A21B 1/00

(52) U.S. Cl. 126/19 R; 29/428

(57) ABSTRACT

An appliance has an insulation assembly. The appliance includes a liner defining an appliance chamber. A source of heat is positioned to heat an interior the chamber. An insulation assembly is positioned exterior to the chamber. Insulation includes loose-fill insulation material. The insulation including the loose-fill insulation material is positioned in the insulation assembly.

This application claims the benefit of U.S. Provisional Patent Application No. 61/365,815, filed Jul. 20, 2010, which is hereby incorporated by reference.

### BACKGROUND

The present invention relates to using high temperature insulation. It finds particular application in conjunction with using high temperature insulation with an appliance and will be described with particular reference thereto. It will be appreciated, however, that the invention is also amenable to other applications.

Household appliances, such as for example, ranges, ovens, hot water heaters, dryers and dish washers, can use high heat levels for various purposes, including food preparation, drying and self-cleaning. The high heat levels can be produced within confined chambers. Various energy sources, including electricity, natural gas and propane can be used to produce the high heat levels.

The confined chambers are typically positioned within a cabinet or an enclosure. The cabinet or enclosure typically includes side panels, a top panel and a bottom panel. In some instances, the cabinet or enclosure can also include a back panel and a front panel having a pivoting front door. High temperature insulation can be positioned adjacent to the confined chamber. The high temperature insulation is used to control the flow of heat from the confined chamber to the outside of the cabinet or enclosure.

The present invention provides a new and improved apparatus and method for using high temperature insulation with an appliance.

### SUMMARY

In one aspect of the present invention, it is contemplated that an appliance has an insulation assembly. The appliance includes a liner defining an appliance chamber. A source of heat is positioned to heat an interior the chamber. An insulation assembly is positioned exterior to the chamber. Insulation includes loose-fill insulation material. The insulation including the loose-fill insulation material is positioned in the insulation assembly.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a perspective view of an oven;

FIG. 2 illustrates a schematic representation of a front view, partially in cross-section, of an oven illustrating insulation assemblies positioned around an oven chamber in accordance with one embodiment of an apparatus illustrating principles of the present invention;

FIG. 3 illustrates a schematic representation of a side view, in cross-section, of the oven illustrated in FIG. 2 in accordance with one embodiment of an apparatus illustrating principles of the present invention;

FIG. 4 illustrates a schematic representation of a side view, in cross-section, of the insulation assembly of FIG. 2 in accordance with one embodiment of an apparatus illustrating principles of the present invention;

FIG. 5 illustrates a schematic representation of a side view, in cross-section, of an insulation assembly in accordance with a second embodiment of an apparatus illustrating principles of the present invention;

FIG. 6A illustrates a schematic representation of a side view, in cross-section, of an insulation assembly shown in an unfinished condition in accordance with a third embodiment of an apparatus illustrating principles of the present invention;

FIG. 6B illustrates a schematic representation of a side view, in cross-section, of the insulation assembly of FIG. 6A shown in a finished condition in accordance with one embodiment of an apparatus illustrating principles of the present invention;

FIG. 7A illustrates a schematic representation of a side view, in cross-section, of an insulation assembly in accordance with a fourth embodiment of an apparatus illustrating principles of the present invention;

FIG. 7B illustrates a schematic representation of a side view, in cross-section, of an insulation assembly in accordance with a fifth embodiment of an apparatus illustrating principles of the present invention;

FIG. 8A illustrates a schematic representation of a front view, partially in cross-section, of the oven illustrated in FIG. 2 illustrating an alternate insulation configuration; and

FIG. 8B illustrates a schematic representation of a front view, partially in cross-section, of the oven illustrated in FIG. 2 illustrating an alternate insulation configuration.

### DETAILED DESCRIPTION OF ILLUSTRATED EMBODIMENT

The description and figures disclose high temperature insulation assemblies for appliances. Generally, the high temperature insulation assemblies are configured to insulate the external surfaces of an appliance from the heat generated by a heat source within a heated and confined chamber. The term “appliance” as used herein, is defined to mean a piece of equipment configured for performance of a particular task. Various non-limiting examples of appliances include ranges, ovens, hot water heaters, dryers and dish washers. The term “insulate”, as used herein, is defined to mean substantially retard the flow of heat.

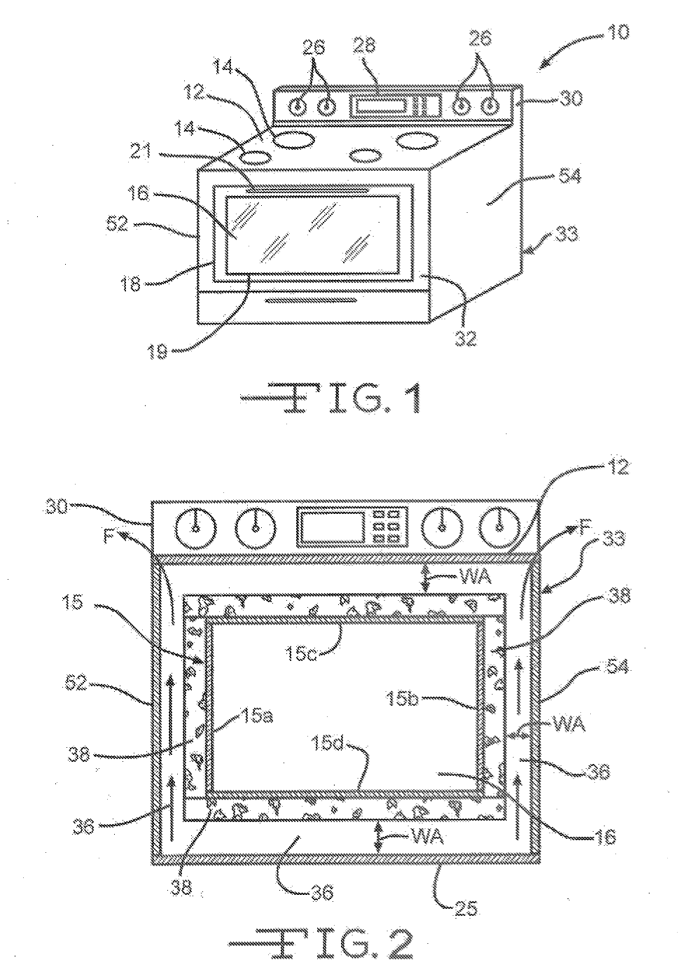

With reference to FIG. 1, one example of an appliance 10. While the embodiment illustrated in FIG. 1 illustrates the appliance 10 to be in the form of an oven, it should be appreciated that in other embodiments, the appliance 10 may take other forms (e.g., a hot water heater). The oven 10 includes a substantially flat, top cooking surface 12. A plurality of heating elements or burners 14 are typically positioned on the top cooking surface 12, although the heating elements or burners 14 are optional. The oven 10 may include a plurality of burner controls 26 configured to control the heat level produced by the burners 14. The oven 10 can also include a control panel 28 for controlling the temperature generated within an appliance chamber 16 (e.g., an oven chamber). In the illustrated embodiment, the burner controls 26 and control panel 28 are mounted on a backsplash 30. However, it should be understood that the burner controls 26 and the control panel 28 can be positioned in other locations of the oven 10. The backsplash 30 is located on a back edge of the cooking surface 12. The backsplash 30 typically extends away from the cooking surface 12 in an upwardly and perpendicular direction. Although the illustrated embodiment shows a backsplash 30, it should be appreciated that in other embodiments, the oven 10 may not have a backsplash 30. While the illustrated embodiment shows the oven 10 having a top cooking surface 12 with a plurality of burners 14, it should be appreciated that other types of ranges or ovens, such as the non-limiting example of a wall oven without a top cooking surface can be used.

With reference to FIGS. 1-3, the oven 10 includes a pair of opposed side panels 52, 54, a back panel 24, a bottom panel 25, and a front panel 32. The opposed side panels 52, 54, back panel 24, bottom panel 25, front panel 32, and cooking surface 12 are configured to form an outer oven cabinet 33. The outer oven cabinet 33 may be finished with any desired finish. In certain embodiments, the panels 52, 54, 24, 25, 32 and the cooking surface 12 can have an aesthetically pleasing finish, such as for example a painted finish, a porcelain enamel finish or a brushed stainless steel finish.

The front panel 32 includes a pivotally connected, insulated oven door 18. The oven door 18 is hinged at a lower end to the front panel 32 such that the oven door can be pivoted away from the front panel 32 and the oven chamber 16. Optionally, the oven door 18 may include a window 19. The window 19 is typically made of glass, in order that the user can view the contents of the oven chamber 16 during its use. Optionally, the oven door 18 may include a handle 21 configured to facilitate moving the oven door 18 from an open position to a closed position and visa versa.

With reference to FIGS. 2 and 3, the oven cabinet 33 supports an inner appliance liner 15 (e.g., an inner oven liner). The inner oven liner 15 includes opposing liner side panels 15a, 15b, a liner top panel 15c, a liner bottom panel 15d, and a liner back panel 15e. The opposing liner side panels 15a, 15b, liner top panel 15c, liner bottom panel 15d, liner back panel 15e, and oven door 18 are configured to define the oven chamber 16.

With reference again to FIGS. 2 and 3, the exterior surfaces of the oven liner 15 are covered by a plurality of insulation assemblies 38. The insulation assemblies 38 are placed adjacent to and, optionally in contact with, the exterior surfaces of the oven liner 15 and are configured to retain heat generated within an interior of the oven chamber 16. In one embodiment, a heat source is positioned to heat the interior of the oven chamber 16. The insulation assemblies 38 are also configured to reduce the rate of heat transfer to the outer oven cabinet 33. The insulation assemblies 38 may be retained in position against the exterior surfaces of the oven liner 15 by retaining structures (not shown), including the non-limiting limiting examples of straps, wire and metallic panels. The insulation assemblies 38 will be discussed in more detail below.

An air gap 36 may be formed between the insulation assemblies 38 and the outer oven cabinet 33. In certain embodiments, the air gap 36 can be configured as another insulative layer, thereby further reducing the rate of heat transfer between oven chamber 16 and the oven cabinet 33. The use of the air gap 36 may supplement the insulation assemblies 38 to minimize the surface temperatures on the outer surfaces of the oven cabinet 33. The air gap 36 has a width WA. In the illustrated embodiment, the width WA of the air gap 36 is in a range of from about 0.50 inches to about 1.50 inches. In other embodiments, the width WA of the air gap 36 can be less than about 0.50 inches or more than about 1.50 inches. While the illustrated embodiment of the oven 10 shows the widths WA of the air gaps 36 adjacent the panels 52, 54, the back panel 24, the bottom panel 25, and the front panel 32 to be approximately the same dimension, it should be appreciated that in other embodiments, the widths WA of the air gaps 36 adjacent the panels 52, 54, the back panel 24, the bottom panel 25, and the front panel 32 may be different dimensions.

With reference again to FIG. 2, hot air can enter or be formed within the air gap 36 during use of the oven 10. The hot air flows within the air gap 36 in a generally upward direction as indicated by the arrows F. The hot air exits the oven 10 through gaps between the side panels, 52, 54, and the top cooking surface 12. Optionally, chimney structures (not shown) can be positioned in the air gap 36 to facilitate the flow of the hot air from the air gap 36. The chimney structures can have any desired shape or configuration.

With reference to FIG. 4, a first embodiment of an insulation assembly 38 includes a first enclosure material 60, a second enclosure material 62 and an insulation layer 64 positioned therebetween. Generally, the first enclosure material 60 and the second enclosure material 62 are configured to form an insulation cavity within which the insulation layer 64 is positioned. In the illustrated embodiment, the first enclosure material 60 and the second enclosure material 62 are formed from either a rigid or flexible non-woven web of fibrous mineral material, such as the non-limiting example of glass fibers. However, in other embodiments the first enclosure material 60 and the second enclosure material 62 can be formed from other desired materials sufficient to form an insulation cavity, including the non-limiting examples of woven fibrous mineral materials and metallic materials, such as for example foil. In yet other embodiments, the enclosure materials, 60, 62, can be formed from porous materials to facilitate filling of the insulation cavity with the insulation layer 62. While in the illustrated embodiment, the first enclosure material 60 and the second enclosure material 62 are formed of the same material, it should be appreciated that in other embodiments the first enclosure material 60 and the second enclosure material 62 can each be formed from different materials.

The enclosure materials, 60, 62, have a material weight. In the illustrated embodiment, the material weight of the enclosure materials, 60, 62, is in a range of from about 40.0 grams per square meter to about 90.0 grams per square meter. Alternatively, the material weight of the enclosure materials, 60, 62, can be less than about 40.0 grams per square meter or more than about 90.0 grams per square meter.

As illustrated in FIG. 4, the first enclosure material 60 has a thickness T1. The thickness T1 is in a range of from about 0.01 inches to about 0.08 inches. In other embodiments, the thickness T1 may be less than about 0.01 inches or more than about 0.08 inches. Similarly, the second enclosure material 62 has a thickness T2. In the illustrated embodiment, the thickness T2 is in a range of from about 0.01 inches to about 0.08 inches. In other embodiments, the thickness T2 can be less than about 0.01 inches or more than about 0.08 inches. While the illustrated embodiment shows the thicknesses T1 and T2 to be about the same, it should be appreciated that in other embodiments, the thicknesses T1, T2 may be different from each other.

The first enclosure material 60 has a major face 70 and opposing end faces 72, 74. Similarly, the second enclosure material 62 has a major face 76 and opposing end faces 78, 80. The end face 72 of the first enclosure material 60 and the end face 78 of the second enclosure material 62, are arranged to overlap each other thereby forming a structure having a closed end and an open end. A plurality of retention members 82 are positioned in the overlapped portion to maintain the overlapped arrangement. In the illustrated embodiment, the retention members 82 are staples. However, in other embodiments, the retention members 82 can be other structures, devices or mechanisms, such as for example clips, clamps, wires or high temperature zippers. In still other embodiments, the overlapped ends, 72, 78 can be connected by high temperature adhesives.

Once the overlapped end of the structure is formed, the first enclosure material 60 and the second enclosure material 62 define an insulation cavity 84 within the structure. As discussed in more detail below, the insulation cavity 84 within the structure is filled with loose-fill insulation material before the open end is closed. The loose-fill insulation material within the insulation cavity 84 forms the insulation layer 64.

The loose-fill insulation used to form the insulation layer 64 can be any loose-fill insulation, such as a multiplicity of discrete, individual tuffs, cubes, flakes, or nodules. The term “tuft”, as used herein, is defined to mean any cluster of insulative fibers. The loose-fill insulation material can be made of glass fibers or other mineral fibers, and can also be organic fibers, thermoplastic fibers or cellulose fibers. In the illustrated embodiment, the loose-fill insulation material is binderless. However, in other embodiments, the loose-fill insulation material can include a binder material, including the non-limiting example of a high-temperature binder. In the illustrated embodiment, the loose-fill insulation material has an average fiber diameter in a range of from about 0.1 microns to about 20.0 microns. Without being held to the theory, it is believed that the relatively small average diameter of the fibers within the loose-fill insulation material provides increased insulative value (R value) over loose-fill insulation materials having larger average fiber diameters. Alternatively, the loose-fill insulation material can have an average fiber diameter less than about 0.1 microns or more than about 20.0 microns.

The loose-fill insulation material is inserted into the open end of the insulation cavity 84 formed by the first enclosure material 60 and the second enclosure material 62, thereby forming the insulation layer 64. As discussed below, after the loose-fill insulation is inserted into the insulation cavity 84, the open end is closed and the insulation cavity 84 is enclosed by, for example, the retention member 82. In the illustrated embodiment, the insulation layer 64 has a density in a range of from about 3.0 pounds per cubic foot (hereafter “pcf”) to about 6.0 pcf. In other embodiments, the insulation layer 64 can have a density less than about 3.0 pcf or more than about 6.0 pcf.

Once the insulation layer 64 is formed, the end faces, 74, 80, of the first and second enclosure materials, 60, 62, are overlapped and maintained in an overlapped arrangement by a plurality of retention members 82 in the same manner as described above. The first and second enclosure materials, 60, 62, the insulation layer 64 and the overlapped end faces, 72, 78, 74 and 80 form the (enclosed) insulation assembly 38. The insulation assembly 38 has a thickness T3. In the illustrated embodiment, the thickness T3 is in a range of from about 0.50 inches to about 3.0 inches. Alternatively, the thickness T3 can be less than about 0.50 inches or more than about 3.0 inches. The insulation assembly 38 can have any desired width and length. The insulation assemblies 38 are positioned within the oven 10 and against the exterior surfaces of the inner oven liner 15 as discussed above.

During normal cooking operation, the oven chamber 16 will be heated to a cooking temperature in a range of from about 250° F. (121° C.) to about 500° F. (260° C.). When operating in a self-cleaning mode, the oven chamber 16 will be heated to a temperature in a range of from about 750° F. (398° C.) to about 900° F. (482° C.). For commercial or industrial ovens, the temperature within the oven chamber 16 can reach as high as 1600° F. (871° C.). The heat from within the oven chamber 16 can radiate from the oven chamber 16 and the flow of the heat can be retarded by the insulation assemblies 38 and optionally by the air gap 36. In this manner, the insulation assemblies 38 and the air gap 36 cooperate to retard the amount of heat that is transferred to the oven cabinet 33. Heat exposure tests, such as the UL858 Standard for Household Electric Ranges and ANSI Z21.1 Standard for Household Cooking Gas Appliances, require that the maximum allowable surface temperature be 152° F. for a painted metal surface, 160° F. for a porcelain enamel surface, or 172° F. for a glass surface. In addition to meeting the maximum surface temperatures requirements for heat exposure tests, the reduced heat transfer rate of the configuration of the insulation assemblies 38 and the air gap 36 also advantageously provides for reduced power necessary for cooking and self-cleaning modes of operation, and protection of sensitive electronic controls from excessive exposure to high heat.

During self-cleaning mode, insulation including a binder (e.g., fiberglass insulation or loose-fill insulation) exposed to the relatively higher temperatures has been found to produce an unpleasant odor and/or smoke. Binderless insulation (e.g., binderless loose-fill insulation) has been found to eliminate the undesirable odor and/or smoke at relatively higher temperatures (e.g., during self-cleaning mode).

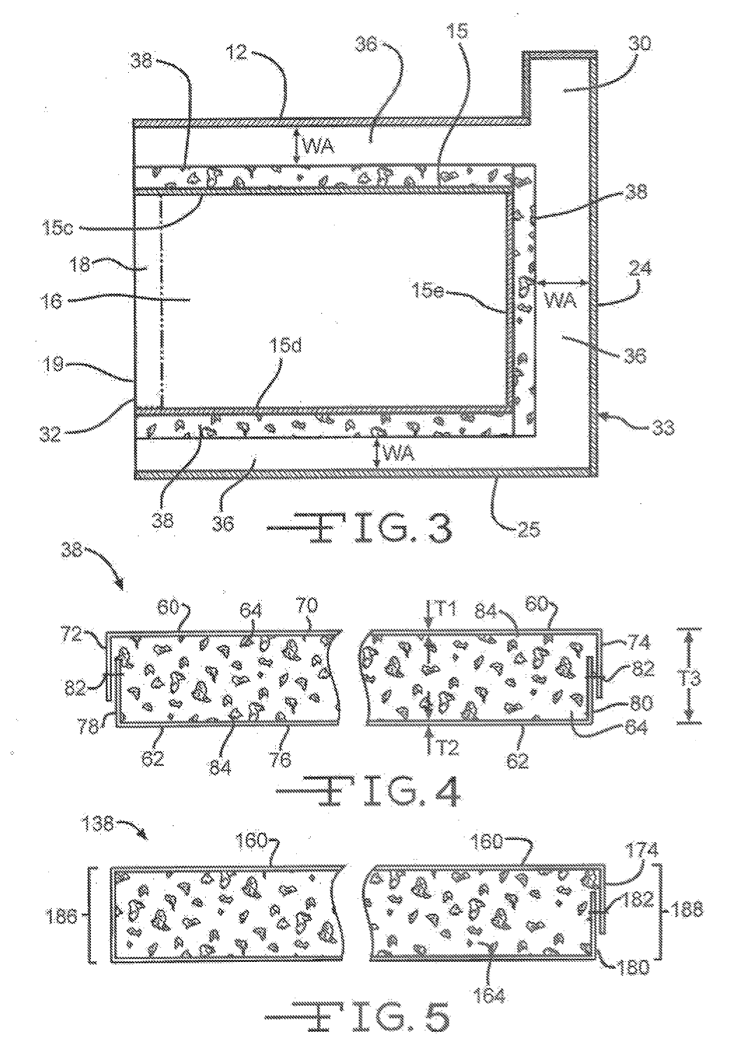

With reference to FIG. 5, a second embodiment of an insulation assembly is illustrated generally at 138. In this embodiment, a single continuous enclosure material is configured to form an insulation cavity. The insulation assembly 138 includes an enclosure material 160 and an insulation layer 164. In the illustrated embodiment, the enclosure material 160 and the insulation layer 164 are the same as, or similar to, the first enclosure material 60 and the insulation layer 64 discussed above and illustrated in FIG. 4. However, in other embodiments, the enclosure material 160 may be different from the first enclosure material 60 and the insulation layer 164 can be different from the insulation layer 64.

As illustrated in FIG. 5, the enclosure material 160 has a formed end 186 and an overlapped end 188. In the illustrated embodiment, the formed end 186 has the approximate cross-sectional shape of a rectangle. However, in other embodiments, the formed end 186 can have other cross-sectional shapes, including the non-limiting example of a rounded cross-sectional shape. As further shown in FIG. 5, the overlapped end 188 includes end faces 174, 180. The end faces 174, 180 are overlapped and connected together by a plurality of retention members 182. In the illustrated embodiment, the retention members 182 are the same as, or similar to, the retention members 82 discussed above and illustrated in FIG. 4. However, in other embodiments, the retention members 182 may be different from the retention members 82. Once assembled, the insulation assemblies 138 are positioned in the oven 10 as described above and illustrated in FIGS. 2 and 3.

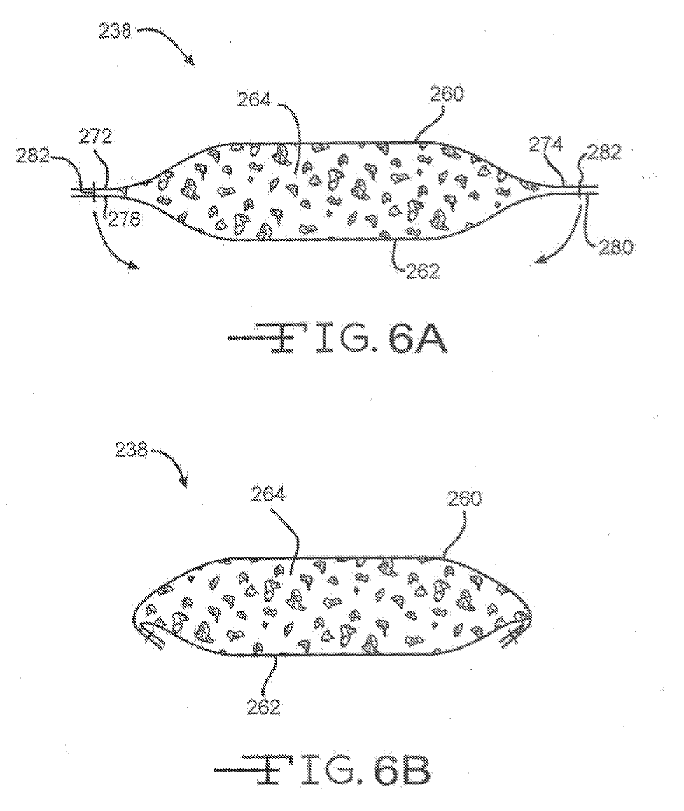

With reference to FIGS. 6A and 6B, a third embodiment of an insulation assembly is illustrated generally at 238. In this embodiment, opposing enclosure materials are configured to form an insulation cavity. The insulation assembly 238 includes a first enclosure material 260, a second enclosure material 262 and an insulation layer 264. In the illustrated embodiment, the enclosure materials, 260, 262, and the insulation layer 264 are the same as, or similar to, the enclosure materials 60, 62, and the insulation layer 64 discussed above and illustrated in FIG. 4. However, in other embodiments, the enclosure materials 260, 262 may be different from the enclosure materials 60, 62, and the insulation layer 264 may be different from the insulation layer 64.

As illustrated in FIG. 6A, the enclosure material 260 has end flaps 272 and 188. Similarly, the enclosure material 262 has end flaps 278, 280. The end flap 272 of the first enclosure material 260 and the end flap 278 of the second enclosure material 262 are joined. The end flaps 272, 278 are joined using a plurality of mechanical fasteners 282 (e.g., staples). However in other embodiments, the end flaps 272, 278, can be joined using other processes and structures.

Once the end flaps 272, 278 are joined, the first enclosure material 260 and the second enclosure material 262 define an insulation cavity 284. The insulation cavity 284 is subsequently filled with loose-fill insulation material. Once the insulation layer 264 is formed, the end flaps 274, 280 are joined, thereby forming the insulation assembly 238. The end flaps 274, 280 are joined in the same manner as described above.

With reference to FIG. 6B, the joined end flaps 272, 278 are rotated or folded such as to be adjacent the second enclosure material 262 and the joined end flaps 274, 280 are also rotated or folded such as to be adjacent the second enclosure material 262, thereby forming the insulation layer 264. Once assembled, the insulation assemblies 238 can be positioned in the oven 10 as described above and illustrated in FIGS. 2 and 3.

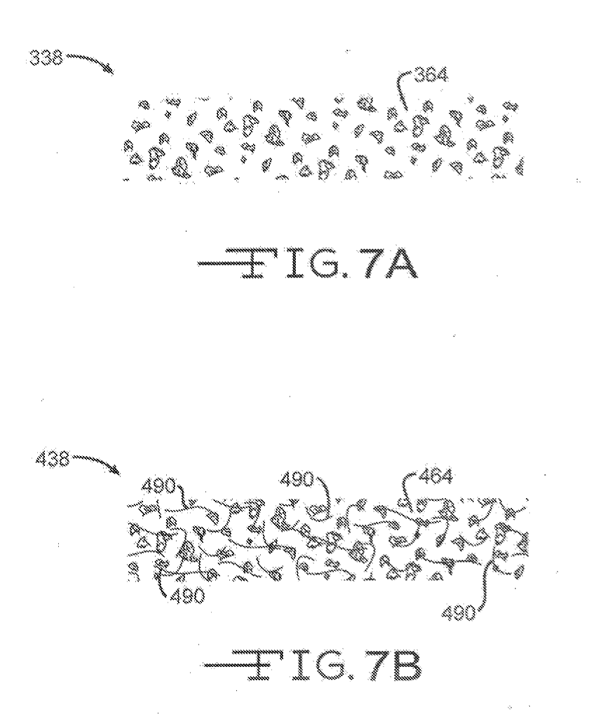

With reference to FIG. 7A, a fourth embodiment of an insulation assembly is illustrated generally at 338. The insulation assembly 338 is formed from a pack of fibrous loose-fill insulation material 364. In the illustrated embodiment, the fibrous loose-fill insulation material 364 is the same as, or similar to, the loose-fill insulation material 64 discussed above and illustrated in FIG. 4. However, in other embodiments, the fibrous loose-fill insulation material 364 may be different from the fibrous loose-fill insulation material 64.

With reference again to FIG. 7A, the insulation assembly 338 having the fibrous loose-fill insulation material 364 can be formed in any desired manner. In one example of a forming process, individual tufts of the fibrous loose-fill insulation material 364 can be entangled with other individual tufts of the fibrous loose-fill insulation material 364 by the process of needling. One example of the needling process is disclosed in the U.S. Patent Application Publn. No. 2007/0014995 (Chacko et al.) published Jan. 18, 2007, the disclosure of which is incorporated herein by reference. However, it should be appreciated that the insulation assembly 338 having the entangled fibrous loose-fill insulation material 364 can be formed in any desired manner. The process of entangling the fibrous loose-fill insulation material 364 is configured to provide strength to the fibrous loose-fill insulation material 364 such that the insulation assembly 338 generally retains its shape.

After the insulation assembly 338 having the entangled fibrous loose-fill insulation material 364 is formed, the insulation assembly 338 can be cut to any desired shape and size using any desired cutting process, including the non-limiting example of die cutting.

The insulation assembly 338 having the entangled fibrous loose-fill insulation material 364 has a density. In the illustrated embodiment, the insulation assembly 338 has a density in a range of from about 3.0 pcf to about 6.0 pcf. In other embodiments, the insulation assembly 338 can have a density less than about 3.0 pcf or more than about 6.0 pcf.

With reference to FIG. 7B, a fifth embodiment of an insulation assembly is illustrated generally at 438. The insulation assembly 438 is formed from a pack of fibrous loose-fill insulation material 464. In the illustrated embodiment, the fibrous loose-fill insulation material 464 is the same as, or similar to, the loose-fill insulation material 64 discussed above and illustrated in FIG. 4. However, in other embodiments, the fibrous loose-fill insulation material 464 can be different from the fibrous loose-fill insulation material 64.

The pack of fibrous loose-fill insulation material 464 is entangled with fibers 490 having a longer length than the fibers of the fibrous loose-fill insulation material 464. The entangled fibers 490 are configured to provide strength to the fibrous loose-fill insulation material 464 such that the pack generally retains its shape. In addition to having a longer length than the fibers of the fibrous loose-fill insulation material 464, the entangled fibers 490 also have a larger average diameter than the average diameter of the fibers of the fibrous loose-fill insulation material 464. In the illustrated embodiment, the average diameter of the entangled fibers 490 is in a range of from about 10 microns to about 30 microns. In other embodiments, the average diameter of the entangled fibers 490 can be less than about 10 microns or more than about 30 microns.

With reference again to FIG. 7B, the entangled fibers 490 have an average length in a range of from about 0.50 inches to about 3.0 inches. However, it should be appreciated that in other embodiments, the average length of the entangled fibers 490 can be less than about 0.50 inches or more than about 3.0 inches.

The fibrous loose-fill insulation material 464 and the entangled fibers 490 can be formed together in any desired proportions. In the illustrated embodiment, the proportion of the fibrous loose-fill insulation material 464 is in a range of from about 20.0% to about 95.0% by weight and the proportion of the entangled fibers 490 is in a range of from about 5.0% to about 80.0% by weight. However, in other embodiments, the proportion of the fibrous loose-fill insulation material 464 can be less than about 20.0% or more than about 95.0% and the proportion of the entangled fibers 490 can be less than about 5.0% or more than about 80.0%.

With reference again to FIG. 7B, the pack having the entangled fibers 490 and the fibrous loose-fill insulation material 464 may be formed in any desired manner. In one example of a forming process, the entangled fibers 490 may be entangled with the fibrous loose-fill insulation material 464 by the process of needling. One example of the needling process is disclosed in the US Patent Application Publn. No. 2007/0014995 (Chacko et al.) as discussed above. However, it should be appreciated the pack having the entangled fibers 490 and the fibrous loose-fill insulation material 464 can be formed in any desired manner.

After the pack having the entangled fibers 490 and the fibrous loose-fill insulation material 464 is formed, the pack may be cut to any desired shape and size using any desired cutting process, including the non-limiting example of die cutting.

The pack having the entangled fibers 490 and the fibrous loose-fill insulation material 464 has a density. In the illustrated embodiment, the pack has a density in a range of from about 3.0 pcf to about 6.0 pcf. In other embodiments, the pack has a density less than about 3.0 pcf or more than about 6.0 pcf.

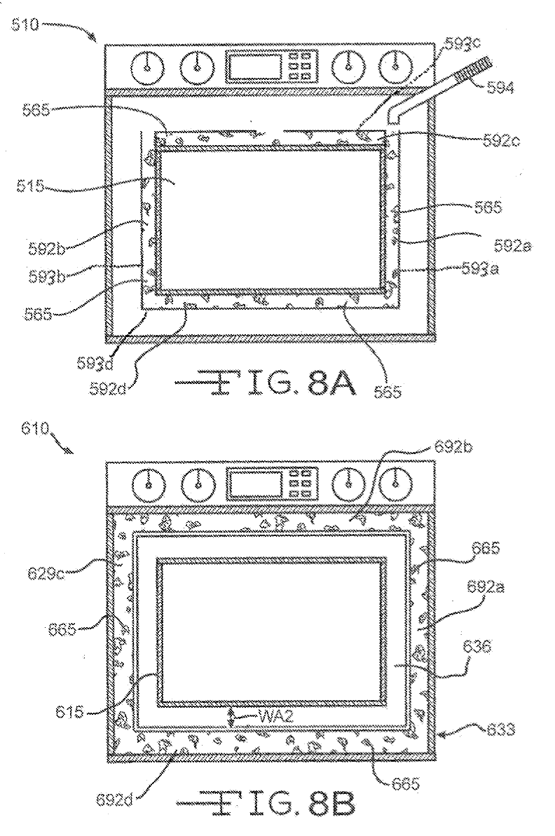

With reference to FIG. 8A, another embodiment of an oven 510 is illustrated. In this embodiment, a plurality of insulation cavities 592a, 592b, 592c, 592d are formed proximate (adjacent) to and around an oven liner 515 and defined by veil walls 593a, 593b, 593c, 593d, respectively. It is contemplated that the veil walls 593a, 593b, 593c, 593d include the material discussed above for the enclosure material. The veil walls 593a, 593b, 593c, 593d are spaced from a wall defining the oven liner 515 to create the insulation cavities 592a, 592b, 592c, 592d defined by the veil walls 593a, 593b, 593c, 593d and respective walls of the oven liner 515. Therefore, in this embodiment, the loose-fill insulation material 565 directly contacts an exterior surface of the oven liner 515 walls and the veil walls 593a, 593b, 593c, 593d. The insulation cavities 592a, 592b, 592c, 592d are configured to be filled with loose-fill insulation material 565. In the illustrated embodiment, the loose-fill insulation material 565 is the same as, or similar to, the loose-fill insulation material forming the insulation layer 64 discussed above and illustrated in FIG. 4. However, the loose-fill insulation material 565 can be different from the loose-fill insulation material forming the insulation layer 64.

The loose-fill insulation material 565 may be inserted into (e.g., blown into) the insulation cavities 592a, 592b, 592c, 592d by an applicator 594. The applicator 594 can have any desired shape, size, or configuration. In still other embodiments, the loose-fill insulation material 565 can be inserted into the insulation cavities 592a, 592b, 592c, 592d by other desired structures, mechanisms, or devices, including the non-limiting example of a pressurized hopper (not shown).

While the insulation cavities 592a, 592b, 592c, 592d illustrated in FIG. 8A are shown as having substantially rectangular forms, it should be appreciated that in other embodiments, the insulation cavities 592a, 592b, 592c, 592d can be any shape, size, or configuration sufficient to retain the loose-fill insulation material 565 in an insulating orientation against the inner over liner 515.

With reference to FIG. 8B, another embodiment of an oven 610 is illustrated. In this embodiment, an air gap 636 is formed around an over liner 615 and insulation cavities 692a, 692b, 692c, 692d are formed around the air gap 636. The insulation cavities 692a, 692b, 692c, 692d are configured to be filled with loose-fill insulation material 665. In the illustrated embodiment, the loose-fill insulation material 665 is the same as, or similar to, the loose-fill insulation material forming the insulation layer 64 discussed above and illustrated in FIG. 4. However, the loose-fill insulation material 665 may be different from the loose-fill insulation material forming the insulation layer 64.

The loose-fill insulation material 665 may be inserted into the insulation cavities 692a, 692b, 692c, 692d by any desired manner including using the applicator 594 as illustrated in FIG. 8A.

While the insulation cavities 692a, 692b, 692c, 692d illustrated in FIG. 8B are shown as having substantially rectangular forms, it should be appreciated that in other embodiments, the insulation cavities 692a, 692b, 692c, 692d can be any shape, size, or configuration sufficient to retain the loose-fill insulation material 665 in an insulating orientation against the inner over liner 615.

The air gap 636 is used as a further insulator to limit the conductive heat transfer between oven liner 615 and the outer oven cabinet 633. The use of the air gap 636 supplements the insulation material 665 to minimize the surface temperatures on the outer surfaces of the outer oven cabinet 633. In the embodiment shown in FIG. 8B, the air gap 636 has a width WA2. In this embodiment, the width WA2 is in a range from about 0.50 inches to about 1.5 inches. In another embodiment, the width WA2 can be less than about 0.50 inches or more than about 1.5 inches.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. An appliance having an insulation assembly, the appliance comprising:
a liner defining an appliance chamber;
a source of heat positioned to heat an interior the chamber;
an insulation assembly positioned exterior to the chamber; and
insulation, including loose-fill insulation material, positioned in the insulation assembly.

2. The appliance as set forth in claim 1, wherein:
the insulation assembly includes at least one enclosure material configured to form an insulation cavity; and
the insulation is positioned in the insulation cavity.

3. The appliance as set forth in claim 2, wherein:
the insulation assembly includes a plurality of the enclosure materials configured to enclose the insulation cavity; and
the insulation is positioned in the enclosed insulation cavity.

4. The appliance as set forth in claim 2, wherein:
one of the enclosure materials overlaps another one of the enclosure materials to form the insulation cavity.

5. The appliance as set forth in claim 2, wherein:
the loose-fill insulation material is blown into the insulation cavity.

6. The appliance as set forth in claim 2, wherein:
the insulation cavities are defined by respective walls of the appliance chamber and respective ones of the enclosure material.

7. The appliance as set forth in claim 1, wherein the loose-fill insulation includes individual tufts entangled with each other.

8. The appliance as set forth in claim 1, wherein:
the loose-fill material is entangled with fibers.

9. The appliance as set forth in claim 8, wherein:
the loose-fill insulation material has an average fiber diameter in a range of from about 0.1 microns to about 20 microns;
the entangled fibers have an average diameter in a range of from about 10 microns to about 30 microns; and
the entangled fibers have a length in a range from about 0.50 inches to about 3.0 inches.

10. The appliance as set forth in claim 2, further including:
an air gap between the liner and the insulation assembly.

11. The appliance as set forth in claim 2, further including:
an air gap exterior to both the liner and the insulation assembly.

12. The appliance as set forth in claim 2, further including:
an outer appliance cabinet, the insulation assembly limiting a temperature of the outer appliance cabinet to about 152° F. if the outer appliance cabinet is painted, to about 160° F. if the outer appliance cabinet is porcelain, and to about 172° F. if the outer appliance cabinet is glass, when a temperature in the appliance chamber is about 900° F.

13. A method for insulating a chamber in an appliance, the method comprising:
defining an appliance chamber by a liner;
positioning a source of heat to heat an interior of the appliance chamber;
positioning an insulation assembly exterior to an appliance chamber; and
positioning insulation, including loose-fill insulation material, in the insulation assembly.

14. The method for insulating a chamber in an appliance as set forth in claim 13, further including:
positioning the insulation assembly to define an insulation cavity defined by enclosure material;
enclosing the insulation, including the loose-fill insulation material, in the insulation cavity; and
positioning the insulation assembly adjacent to the liner.

15. The method for insulating a chamber in an appliance as set forth in claim 13, further including:
positioning the insulation assembly to define an insulation cavity between an enclosure material and the liner; and
blowing the insulation, including the loose-fill insulation material, into the insulation cavity.

16. The method for insulating a chamber in an appliance as set forth in claim 13, further including:
entangling individual tufts of the loose-fill insulation material with one of each other and other fibers.

17. The method for insulating a chamber in an appliance as set forth in claim 13, further including:
positioning the insulation assembly to provide for an air gap between the insulation and the liner.

18. An insulation assembly for an appliance, the insulation assembly comprising:
at least one enclosure material configured to form an insulation cavity; and
insulation, including loose-fill insulation material, positioned in the insulation cavity.

19. The insulation assembly as set forth in claim 18, wherein:
the enclosure material encloses the insulation in the insulation cavity.

20. The insulation assembly as set forth in claim 18, wherein:
a liner of an associated appliance chamber defines one side of the insulation cavity; and
the enclosure material forms a plurality of additional ones of the sides of the insulation cavity.
